(19) United States
(12) Patent Application Publication
(10) Pub. No.: US 2015/0001155 A1
(43) Pub. Date: Jan. 1, 2015

(54) METHODS AND APPARATUS FOR SYNTHESIS OF STABILIZED ZERO VALENT NANOPARTICLES

(71) Applicant: Corning Incorporated, Corning, NY (US)

(72) Inventor: Benedict Yorke Johnson, Horseheads, NY (US)

(21) Appl. No.: 13/927,808

(22) Filed: Jun. 26, 2013

(51) Int. Cl. B01J 20/32; B01J 20/28; C02F 1/28

(52) U.S. Cl. CPC B01J 20/3295; C02F 1/288; B01J 20/28016
USPC 210/688; 252/176

(57) ABSTRACT

Methods and apparatus provide for zero valent nanoparticles coated with a stabilizer to inhibit oxidation, where the coating includes at least one of activated carbon, graphene, an inorganic oxide, and an organic material.

### BACKGROUND

The present disclosure relates to methods and apparatus for synthesizing stabilized zero valent nanoparticles.

It is clearly desirable to reduce the levels of heavy metals in surface waters, such as streams, rivers and lakes. Such heavy metal contaminants include: cadmium, chromium, copper, lead, mercury, nickel, zinc, and semi-metals such as arsenic and selenium. High concentrations of heavy metals in the environment can be detrimental to a variety of living species, and ingestion of these metals by humans in sufficient quantities can cause accumulative poisoning, cancer, nervous system damage, and ultimately death. Coal-fired power plants and waste incinerators are major sources of heavy metals. Specifically, power plants and incinerators that have flue gas desulfurization systems (wet FGDs) are of concern because wastewater in the purge stream in such systems often contains mercury, selenium and/or arsenic.

Governmental regulations for controlling the discharge of industrial wastewater containing dissolved concentrations of heavy metals into the environment are being tightened. In order to meet such regulations, wastewater is often treated to either remove or reduce such heavy metals to levels at which the water is considered safe for both aquatic and human life prior to discharge of the wastewater into the environment. Conventional treatment processes for removal of heavy metals from water are generally based on chemical precipitation and coagulation followed by conventional filtration. The problem with conventional techniques, however, is that they are not likely to remove sufficient metal concentrations to achieve the low ppb levels required by the ever more stringent drinking water standards set by the government.

Some artisans have employed zero valent nanoparticles to remove heavy metals from wastewater. Nanoparticles have been found to be attractive for remediation of various contaminants because of their unique physiochemical properties, especially their high surface area. Indeed, as nanoparticles are extremely small, a high surface area to mass ratio exists, making them much more reactive compared to coarser predecessors, such as iron filings. Nevertheless, the existing technologies for synthesizing zero valent nanoparticles has left much room for improvement, especially as concerns a number of challenging characteristics of zero valent nanoparticles, namely: (i) in dry form they are extremely volatile, they have poor oxidization resistance, and they ignite immediately in the presence of air; and (ii) they have a tendency to agglomerate in a liquid dispersion.

Consequently, storage and/or transportation of dry zero valent nanoparticles are only possible in an inert atmosphere. Therefore, zero valent nanoparticles are usually provided in slurry form. Even in slurry form, however, zero valent nanoparticles oxidize fairly rapidly.

In order to stabilize zero valent nanoparticles, some artisans have used a variety of stabilizing agents, surfactants and capping agents. However, the known modifiers are expensive and, therefore, would not be economical for large-scale applications. To suppress oxidation and protect zero valent nanoparticles during a drying process (after synthesis), known methods employ an anaerobic chamber, lyophillization and/or vacuum drying techniques. Unfortunately, all of these methods are expensive, complicated and generate secondary problems, such as requiring subsequent processes for removing environmental pollutants.

Accordingly, there are needs in the art for new methods and apparatus for the synthesis of zero valent nanoparticles.

### SUMMARY

One or more embodiments disclosed herein provide processes and apparatus for synthesizing zero valent nanoparticles for use in any number of applications, such as for removing dissolved heavy metals from aqueous solutions.

Use of Zero valent iron (ZVI) nanoparticles has been emerging as a promising option for removal of heavy metals from industrial wastewaters. ZVI (Fe⁰) nanoparticles have been used in the electronic and chemical industries due to their magnetic and catalytic properties. Use of ZVI nanoparticles is becoming an increasingly popular method for treatment of hazardous and toxic wastes and for remediation of contaminated water. Conventional applications have focused primarily on the electron-donating properties of ZVI. Under ambient conditions, ZVI is fairly reactive in water and can serve as an excellent electron donor, which makes it a versatile remediation material. ZVI nanoparticles, due to their extremely high effective surface area, can enhance the reduction rates markedly. ZVI nanoparticles have been shown to effectively transform and detoxify a wide variety of common environmental contaminants, such as chlorinated organic solvents, organochlorine pesticides, and PCBs, nitrate, hexavalent chromium and various heavy metal ions.

Despite advances in ZVI nanoparticle technology and modest commercialization, several barriers have prevented its use as a widely adopted remediation option. There are technical challenges that have limited the technology, including problems of synthesis and problems of application. Among the problems in the syntheses of ZVI nanoparticles is the inherent environmental instability of the particles themselves. Without any protection, ZVI nanoparticles oxidize as soon as they come in contact with air. As to problems of application, in water ZVI nanoparticles behave as any other nanoparticles in that they aggregate and eventually settle, thereby making it difficult to carry out a specific reaction efficiently and effectively. In water treatment and metal recovery applications, ZVI nanoparticles may be employed in powder form, granular form and/or fibrous form in batch reactors and column filters. Within the reactor or filter, however, the ZVI nanoparticles rapidly fuse into a mass due to formation of iron oxides. This fusion significantly reduces the hydraulic conductivity of the iron bed and the efficacy of the treatment rapidly deteriorates.

Although some have taken steps to overcome these drawbacks, they have proved to be less than acceptable for low cost and practical water treatment applications. For example, one approach has been to immobilize iron nanoparticles on particulate supports, such as silica, sand, alumina, activated carbon, titania, zeolite, etc., in order to prevent ZVI nanoparticle aggregation and rapid deactivation. Although this approach has enhanced the speed and efficiency of remediation, the problem remains that it requires a follow up filtration, just like processes employing free standing ZVI nanoparticles. Filtration methods, including membrane filtration, reverse osmosis, electrodialysis reversal and nanofiltration are expensive and difficult to implement and operate. Further, disposal of the waste that is generated during water treatment and follow up filtration is also problematic because, for example, membranes consistently clog and foul. A further problem is that the use of a particulate support only addresses the agglomeration of ZVI nanoparticles, but offers no protection against the rapid loss of reactivity due to oxidation.

One or embodiments herein provide for the synthesis of air stabilized zero valent nanoparticles. The zero valent nanoparticles are stabilized in order to inhibit oxidation, ignition, etc., by coating the nanoparticles with protective materials, such as one or more inorganic oxides, activated carbon, graphene, one or more organic materials, etc.

The advantages of employing the methodologies and apparatus disclosed herein include: (i) good stabilization of the nanoparticles, thereby preventing agglomeration, preventing rapid deactivation, and enhancing the speed and efficiency of remediation; (ii) enabling the storage and transportation of the nanoparticles in dry form in a normal, air atmosphere (no slurry required); and (iii) wide applicability as a highly selective metal sorbent to capture, concentrate and reduce the concentration of heavy metals from contaminated water.

Other aspects, features, and advantages will be apparent to one skilled in the art from the description herein taken in conjunction with the accompanying drawings.

### DESCRIPTION OF THE DRAWINGS

For the purposes of illustration, there are forms shown in the drawings that are presently preferred, it being understood, however, that the embodiments disclosed and described herein are not limited to the precise arrangements and instrumentalities shown.

FIG. 1 is a schematic view of a system for treating contaminated water using stabilized zero valent nanoparticles;

FIG. 2 is a schematic, microscopic view of coated (and thereby stabilized) zero valent nanoparticles;

FIG. 3 is a schematic view of a structure for immobilizing the zero valent nanoparticles on a substrate; and

FIG. 4 is chart showing numerous plots evidencing the stability of the coated zero valent nanoparticles.

### DETAILED DESCRIPTION OF THE PREFERRED EMBODIMENTS

Various embodiments disclosed herein are directed to processes and apparatus for synthesizing zero valent nanoparticles, particularly stabilized zero valent nanoparticles, which may be used in processes for reducing heavy metals in wastewater effluents, such as those generated by mineral and/or metal processing systems, coal-fired power plant FGD wastewater, etc.

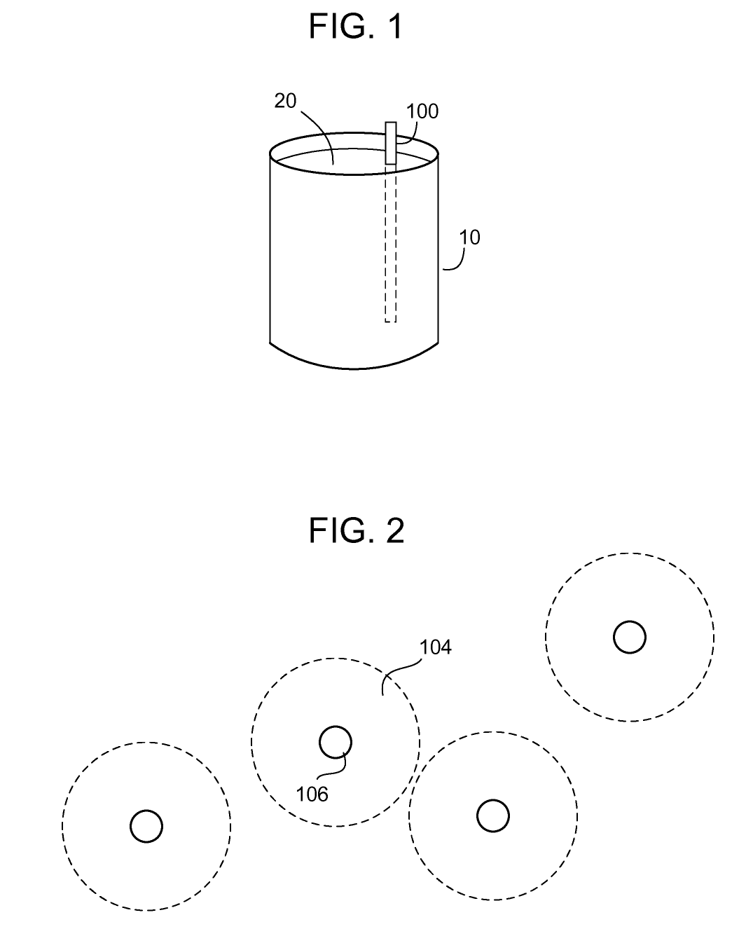

With reference to FIG. 1, a schematic representation of a treatment system shows a vessel 10, which contains contaminated water 20. Treatment of the water 20 is achieved by introducing stabilized zero valent nanoparticles into the vessel 10, which introduction may be achieved in any number of ways, such as by suspension of the stabilized zero valent nanoparticles within the water 20 and/or by inserting a treatment structure 100 (on which the zero valent nanoparticles are immobilized) into the water 20. In either case, the zero valent nanoparticles are immersed into the contaminated water 20 and agitation is optionally applied until the heavy metals are drawn to, and/or bond to, the nanoparticles. The zero valent nanoparticles are then removed from the water 20, carrying the heavy metals, and leaving an acceptable level of contaminants (if any) in the water 20.

FIG. 2 is a schematic, microscopic view of a number of zero valent nanoparticles 106 that are encapsulated or coated by a stabilizer 104 to inhibit oxidation. In essence, the stabilizer 104 forms an hermetic seal (at least to oxygen atoms). By way of example, the zero valent nanoparticles 106 may include at least one of iron, lithium, and nickel. The coating 104 may include at least one of activated carbon, graphene, an inorganic oxide, and an organic material. For example, when the coating 104 is an inorganic oxide, such oxide may be at least one of SiO2, Al2O3, CeO2, ZrO2, TiO2, SnO2, MgO, ZnO, Nb2O5, Cr2O3, CdO, and WO3. Alternatively, when the coating 104 is an organic material, such material is at least one of xanthan polysaccharide, polyglucomannan polysaccharide, emulsan, an alginate biopolymer, hydroxypropyl methylcellulose, carboxy-methyl cellulose, ethyl cellulose, chitin, chitosan, polyvinyl alcohol, polyvinyl esters, polyvinyl amides, copolymers of polylactic acid, and combinations thereof.

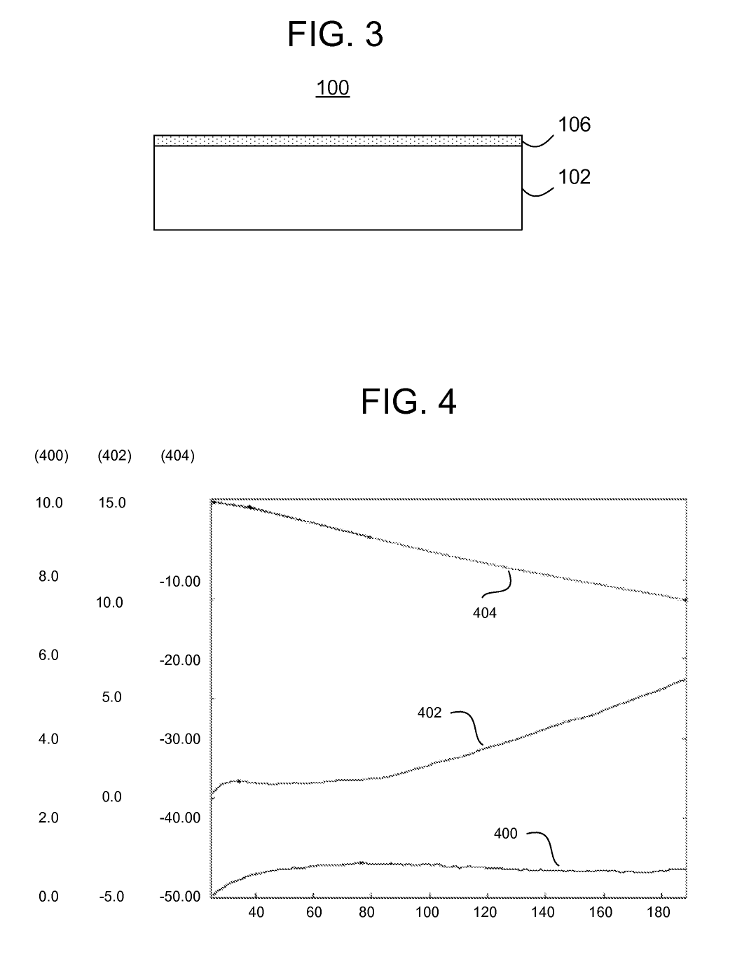

As illustrated in FIG. 3, the coated zero valent nanoparticles 106 may be immobilized on a substrate 102, thereby producing the apparatus 100 discussed above with reference to FIG. 1. The substrate 102 may be formed from, for example, ceramic or alumina.

The basic process for synthesizing the zero valent nanoparticles 106 includes: (i) reducing a salt containing a precursor for the zero valent nanoparticles 106 in a solution containing a surfactant; (ii) separating the zero valent nanoparticles 106 from the solution; and (iii) coating the zero valent nanoparticles 106 with the stabilizer 104 to inhibit oxidation. The coating provides the hermetic encapsulation feature without disturbing the electron affinity of heavy metals to the zero valent nanoparticles 106.

By way of example, when the zero valent nanoparticles 106 are to be iron, the salt may be taken from the group consisting of: ferric chloride (FeCl3), ferrous chloride (FeCl2), ferric sulfide (Fe2(SO4)3), ferrous sulfide (FeSO4), ferric nitride (Fe(NO3)3, ferric bromide (FeBr3), ferrous bromide (FeBr2), and combinations thereof.

As discussed above, zero valent nanoparticles 106 are susceptible to agglomeration and oxidation during the pendency of their use, and there is no exception during synthesis. In order to address these rather undesirable characteristics, the solution may be an aqueous ethanol solution (instead of pure water), which serves to prevent oxidation of zero valent nanoparticles 106 during the reduction reaction. In addition, at least one of an acid, ascorbic acid, and oleic acid surfactant provides steric stabilization that hinders particle agglomeration during synthesis and also partially protects the synthesized particles from oxidation in air or water.

A compound containing an electron donor is slowly added into the solution in an excess stoichiometric amount of the electron donor as compared to the salt. For example, a molar ratio of the electron donor to the salt may be within about 2.0-5.0 times a stoichiometric ratio of the electron donor to the salt. To illustrate the details of this sub-process, the compound may be sodium borohydride (NaBH4-). Therefore, to add an excess stoichiometric amount of the electron donor (BH4-) to the solution, the molar ratio of the electron donor (BH4-) to the salt is controlled to be within about 2.0-5.0 times a stoichiometric ratio of (BH4-) to the salt. As the compound is slowly added, the solution may be vigorously stirred or otherwise agitated for a time sufficient to permit a reaction to occur, such as about 10-30 minutes. Thereafter, the zero valent nanoparticles 106 may be separated from the solution and washed, for example, in water and ethanol (which again prevents oxidation).

As discussed above, the step of coating the zero valent nanoparticles 106 includes coating with at least one of activated carbon, graphene, an inorganic oxide; and an organic material. There are a number of approaches to achieving the coating step. For example, the separated zero valent nanoparticles 106 may be added to stable aqueous graphene oxide solution. Sodium borohydride (NaBH4-) may then be added to the solution, preferably under vigorous stirring or agitation, and permitting a reaction to occur. Next, the graphene coated zero valent nanoparticles 106 are separated from the solution, rinsed thoroughly with de-ionized water and then dried at elevated temperature (e.g., about 120° C.) in an inert atmosphere, such as in an N2 atmosphere.

In an alternative approach, the coating step may be carried out by adding the zero valent nanoparticles 106 to a stable suspension of graphene, and mixing the combination for a period sufficient for a reaction to occur. Thereafter, the graphene coated zero valent nanoparticles 106 are separated from the solution, rinsed with ethanol and dried. The suspension of graphene may be prepared by mild sonication of natural graphite flakes in N-methyl-pirrolidone (NMP) or N,N-dimethylformamide (DMF) at 10 mg/ml for about three hours. Thicker graphitic platelets may be removed by centrifugation at about 4500 rpm for about 30 minutes.

In a further alternative approach, the coating step may be carried out by adding the zero valent nanoparticles 106 to a stable suspension of reduced graphene oxide, and mixing the combination for a period sufficient for a reaction to Occur. Thereafter, the mixture is permitted to dry at elevated temperature, such as about 130° C., in an inert atmosphere, such as in an N2 atmosphere. The graphene oxide suspension may be prepared by hydrothermal reduction of graphene oxide in a sealed autoclave at elevated temperature, such as about 180° C., for about four hours.

The sizes (approximate diameters) of the zero valent nanoparticles 106 range from about 5 nm and higher, such as to about 40-50 nm. Typically, practical and cost-effective methodologies for producing zero valent nanoparticles 106 will result in particle sizes of between about 5 nm to about 10 nm at the low end of the scale. For purposes of the embodiments herein, it is desirable to employ zero valent nanoparticles 106 with relatively small diameters in order to maximize the surface area available to remove the heavy metal contaminants from the water 20. The sizes (approximate diameters) of the zero valent nanoparticles 106 as encapsulated by the stabilizer 104 may range from about 40-100 nm depending on the coating material and number of coating layers.

The coating 104 encapsulating the zero valent nanoparticles 106, provides efficient protection from oxidation by posing a high energy barrier to the path of oxygen atoms. With reference to FIG. 4, a chart shows numerous plots evidencing the stability of the coated zero valent nanoparticles 106. The chart includes multiple scales on the Y-axis; namely, DTG (400) in units of %/mW, DSC (402) in units of mW, and TG (404) in units of %. The scale on the X-axis is temperature in degrees C. The thermogravimetric analysis showed that zero valent iron nanoparticles 106 encapsulated by multilayer graphene 104 were thermally stable up to 200° C. in an air atmosphere. Indeed, a number of samples were heated up to 200° C. in air and TGA curves were plotted. The TGA curve shows a 12.24% total weight loss at the end of the heating cycle, which can be attributed to evaporation of physisorbed water molecules and partial decomposition and desorption of ascorbic acid. The color and size of the zero valent nanoparticles 106 were found unchanged after the heat treatment, indicating that the nanoparticles 106 were not oxidized. The DSC-TGA results clearly show that the graphene coating 104 imparts excellent oxidation resistance to the nanoparticles 106.

A number of experiments were conducted in order to evaluate a number of performance characteristics of the methodologies and apparatus disclosed herein.

In a first example (Example 1), 0.75 g of FeSO4.7H2O and 0.12 g of ascorbic acid were dissolved in 50 ml de-ionized (DI) water. 0.25 g of NaBH4 in 10 ml DI-water was slowly added to the solution (drop-wise) with vigorous stirring for about 20 minutes. The solution slowly turned to a black color. The black particles were separated from the solution via a strong magnet and washed with de-ionized water. The zero valent iron nanoparticles were then capped (encapsulated) with multilayer graphene by adding 15 ml of an aqueous graphene oxide solution (0.5 mg/mL) to the ZVI nanoparticles and mixed. 0.2 g NaBH₄ was then added to the mixture and vigorously stirred. After about 20 minutes, the graphene coated nanoparticles 106 were separated from the solution and dried at about 120° C. in a nitrogen atmosphere.

In order to conduct adsorption studies, the coated zero valent nanoparticles 106 (including Example 1 and further examples discussed below) were immersed in (and then removed from) 45 ml of FGD wastewater containing 30 ppb As, 200 ppb Cd, 2.5 ppm Se, 160 ppb Hg, 220 ppm sulfate, 100 ppm nitrate, 31 ppm chloride, 58 ppm calcium, 17 ppm magnesium and 11 ppm sodium. The adsorbent in solution was agitated in an open or closed system for five to sixteen hours. The changes in metal ion concentrations due to adsorption were then determined and the amounts of adsorbed metal ions were calculated from differences between their concentrations before and after adsorption.

Below, TABLE 1 is a table of data showing the efficacy of the coated zero valent nanoparticles 106 synthesized according to Example 1 for treating contaminated water. The table shows the concentration of metals of concern in the wastewater before and after treatment. An analysis of the residual concentration of the metals reveals that the methodology resulted in excellent removal performance of heavy metal ions by the adsorbent.

TABLE 1

| | | |
|---|---|---|
| Metal | Concentration Before | Concentration After |

| | | | |
|---|---|---|---|
| As | 30 | ppb | <5 ppb |
| Cd | 200 | ppb | <5 ppb |
| Hg | 160 | ppb | <5 ppb |
| Se | 2.3 | ppm | 60 ppb |

In a second example (Example 2), 0.82 g of FeSO4.7H2O and 0.13 g of ascorbic acid were dissolved in 50 ml de-ionized (DI) water. 0.28 g of NaBH4 in 50 ml DI-water was slowly added to the solution (drop-wise) with vigorous stirring for about 20 minutes. The nanoparticles were separated from the solution via a strong magnet and washed with de-ionized water. The zero valent iron nanoparticles were then capped (encapsulated) with multilayer graphene by adding 5 ml of stable graphene suspension (1.0 mg/mL) to the ZVI nanoparticles and mixed. The stable graphene suspension was obtained by chemical exfoliation of graphite with DMF. The mixture was left at room temperature in a nitrogen atmosphere and slight stirring was applied. After about one hour, the nanoparticles were separated from the solution, rinsed with ethanol to remove the DMF, and then dried at about 80° C. in a nitrogen atmosphere.

Below, TABLE 2 is a table of data showing the efficacy of the coated zero valent nanoparticles 106 synthesized according to Example 2 for treating contaminated water. The table shows the concentration of metals of concern in the wastewater before and after treatment. An analysis of the residual concentration of the metals reveals that the methodology and apparatus again resulted in excellent removal performance of heavy metal ions by the adsorbent.

TABLE 2

| | | |
|---|---|---|
| Metal | Concentration Before | Concentration After |

| | | | |
|---|---|---|---|
| As | 30 | ppb | <5 ppb |
| Cd | 200 | ppb | <5 ppb |
| Hg | 160 | ppb | <5 ppb |
| Se | 2.3 | ppm | 70 ppb |

In a third example (Example 3), 2.65 g of FeSO4.7H2O and 0.42 g of ascorbic acid were dissolved in 100 ml de-ionized (DI) water. 0.9 g of NaBH4 in 50 ml DI-water was slowly added to the solution (drop-wise) with vigorous stirring for about 20 minutes. The nanoparticles were separated from the solution via a strong magnet and washed with de-ionized water. The zero valent iron nanoparticles were then capped (encapsulated) with multilayer graphene by adding 15 ml of an aqueous suspension of reduced graphene oxide (1.0 mg/mL) to the ZVI nanoparticles and mixed. The aqueous suspension of reduced graphene oxide was obtained by autoclave reduction of graphene oxide. The mixture was boiled at 130° C. in a nitrogen atmosphere in order to obtain the coated zero valent nanoparticles 106.

Below, TABLE 3 is a table of data showing the efficacy of the coated zero valent nanoparticles 106 synthesized according to Example 3 for treating contaminated water. The table shows the concentration of metals of concern in the wastewater before and after treatment. An analysis of the residual concentration of the metals reveals that the methodology and apparatus again resulted in excellent removal performance of heavy metal ions by the adsorbent.

TABLE 3

| | | |
|---|---|---|
| Metal | Concentration Before | Concentration After |

| | | | | |
|---|---|---|---|---|
| As | 30 | ppb | <5 | ppb |
| Cd | 200 | ppb | <5 | ppb |
| Hg | 160 | ppb | <5 | ppb |
| Se | 2.3 | ppm | 0.55 | ppm |

It is noted that the methodologies, apparatus, and/or mechanisms described in one or more embodiments herein involve the adsorption of the heavy metal onto the coated zero valent nanoparticles 106 (which may be free or immobilized on the substrate 102). In this regard, the zero valent nanoparticles 106 carry the heavy metal contaminant(s) out of or away from the treated water, and therefore the heavy metal remains adsorbed on the zero valent nanoparticles 106 after such treatment has been completed. One option for disposing of the heavy metal is simply to discard the used zero valent nanoparticles 106, such as in a landfill or other modality. Alternatively, skilled artisans may employ any number of well-known regeneration procedures to remove the heavy metal from the zero valent nanoparticles 106 and therefore permit reuse of the zero valent nanoparticles 106 in subsequent treatment procedures.

Additional aspects of zero valent nanoparticles are disclosed in co-pending U.S. application Ser. No. ______, filed Jun. 26, 2013, entitled “METHODS AND APPARATUS FOR MULTI-PART TREATMENT OF LIQUIDS CONTAINING CONTAMINANTS USING ZERO VALENT NANOPARTICLES,” (Attorney Docket No. SP13-195) and in co-pending U.S. application Ser. No. ______, filed Jun. 26, 2013, entitled “METHODS AND APPARATUS FOR TREATMENT OF LIQUIDS CONTAINING CONTAMINANTS USING ZERO VALENT NANOPARTICLES,” (Attorney Docket No. SP13-174) the contents of each are hereby incorporated by reference in their entirety.

Although the disclosure herein has been described with reference to particular embodiments, it is to be understood that the details thereof are merely illustrative of the principles and applications of such embodiments. It is therefore to be understood that numerous modifications may be made to the illustrative embodiments and that other arrangements may be devised without departing from the spirit and scope of the present application.

1. A method, comprising:
reducing a salt containing a precursor for zero valent nanoparticles in a solution containing a surfactant;
separating the zero valent nanoparticles from the solution; and
coating the zero valent nanoparticles with a stabilizer to inhibit oxidation.

2. The method of claim 1, wherein the zero valent nanoparticles include at least one of iron, lithium, and nickel.

3. The method of claim 2, wherein
the zero valent nanoparticles are zero valent iron nanoparticles;
the salt is taken from the group consisting of: ferric chloride (FeCl3), ferrous chloride (FeCl2), ferric sulfide (Fe2(SO4)3), ferrous sulfide (FeSO4), ferric nitride (Fe(NO3)3, ferric bromide (FeBr3), ferrous bromide (FeBr2), and combinations thereof.

4. The method of claim 1, wherein:
the solution is an aqueous ethanol solution; and
the surfactant is at least one of an acid, ascorbic acid, and oleic acid.

5. The method of claim 4, further comprising: adding a compound containing an electron donor into the solution in an excess stoichiometric amount of the electron donor as compared to the salt.

6. The method of claim 5, wherein at least one of:
a molar ratio of the electron donor to the salt is within about 2.0-5.0 times a stoichiometric ratio of the electron donor to the salt; and
the compound is sodium borohydride (NaBH4-).

7. The method of claim 1, wherein the step of separating the zero valent nanoparticles from the solution includes washing the zero valent nanoparticles in water and ethanol.

8. The method of claim 1, wherein the step of coating the zero valent nanoparticles includes coating with at least one of activated carbon, graphene, an inorganic oxide; and an organic material.

9. The method of claim 8, wherein at least one of:
the inorganic oxide is at least one of SiO2, Al2O3, CeO2, ZrO2, TiO2, SnO2, MgO, ZnO, Nb2O5, Cr2O3, CdO, and WO3; and
the organic material is at least one of xanthan polysaccharide, polyglucomannan polysaccharide, emulsan, an alginate biopolymer, hydroxypropyl methylcellulose, carboxy-methyl cellulose, ethyl cellulose, chitin, chitosan, polyvinyl alcohol, polyvinyl esters, polyvinyl amides, copolymers of polylactic acid, and combinations thereof.

10. The method of claim 1, wherein the step of coating the zero valent nanoparticles includes:
adding the zero valent nanoparticles to a stable aqueous graphene oxide solution;
adding sodium borohydride (NaBH4-) and permitting a reaction to occur; and
separating graphene coated zero valent nanoparticles from the solution.

11. The method of claim 1, wherein the step of coating the zero valent nanoparticles includes:
adding the zero valent nanoparticles to a stable suspension of graphene;
mixing the combination and permitting a reaction to occur; and
separating graphene coated zero valent nanoparticles from the solution.

12. The method of claim 1, wherein the step of coating the zero valent nanoparticles includes:
adding the zero valent nanoparticles to a stable suspension of reduced graphene oxide;
mixing the combination and permitting a reaction to occur; and
separating graphene coated zero valent nanoparticles from the solution.

13. An apparatus, comprising:
zero valent nanoparticles; and
a stabilizer coating the zero valent nanoparticles to inhibit oxidation,
wherein the coating includes at least one of activated carbon, graphene, an inorganic oxide, and an organic material.

14. The apparatus of claim 13, wherein at least one of:
the inorganic oxide is at least one of SiO2, Al2O3, CeO2, ZrO2, TiO2, SnO2, MgO, ZnO, Nb2O5, Cr2O3, CdO, and WO3; and
the organic material is at least one of xanthan polysaccharide, polyglucomannan polysaccharide, emulsan, an alginate biopolymer, hydroxypropyl methylcellulose, carboxy-methyl cellulose, ethyl cellulose, chitin, chitosan, polyvinyl alcohol, polyvinyl esters, polyvinyl amides, copolymers of polylactic acid, and combinations thereof.

15. The apparatus of claim 13, wherein the zero valent nanoparticles include at least one of iron, lithium, and nickel.

16. A method of treating water contaminated with one or more heavy metals, comprising bringing the contaminated water into contact with zero valent nanoparticles that are coated with a stabilizer to inhibit oxidation.

17. The method of claim 16, wherein the coating includes at least one of activated carbon, graphene, an inorganic oxide, and an organic material.

18. The method of claim 17, wherein at least one of:
the inorganic oxide is at least one of SiO2, Al2O3, CeO2, ZrO2, TiO2, SnO2, MgO, ZnO, Nb2O5, Cr2O3, CdO, and WO3; and
the organic material is at least one of xanthan polysaccharide, polyglucomannan polysaccharide, emulsan, an alginate biopolymer, hydroxypropyl methylcellulose, carboxy-methyl cellulose, ethyl cellulose, chitin, chitosan, polyvinyl alcohol, polyvinyl esters, polyvinyl amides, copolymers of polylactic acid, and combinations thereof.
